(19) United States
(12) Patent Application Publication
(10) Pub. No.: US 2017/0108946 A1
(43) Pub. Date: Apr. 20, 2017

(54) OPERATING DEVICE

(71) Applicant: TOYOTA JIDOSHA KABUSHIKI KAISHA, Toyota-shi, Aichi-ken (JP)

(72) Inventor: Atsushi NISHIDA, Toyoake-shi (JP)

(73) Assignee: TOYOTA JIDOSHA KABUSHIKI KAISHA, Toyota-shi, Aichi-ken (JP)

(21) Appl. No.: 15/311,348

(22) PCT Filed: May 21, 2015
(86) PCT No.: PCT/IB2015/000723

§ 371 Date: Nov. 15, 2016

(30) Foreign Application Priority Data
May 30, 2014 (JP) 2014-113169

(51) Int. Cl. G06F 3/0362; G06F 3/044; G06F 3/01

(52) U.S. Cl. CPC G06F 3/0362; G06F 3/016; G06F 3/044; G06F 2203/014; G06F 2203/0339; G06F 2203/04105

(57) ABSTRACT

An operating device includes a main body portion having a first touch operating surface and a second touch operating surface which is provided at an angle with respect to the first touch operating surface, a first sensor detecting an operation on the first touch operating surface, a second sensor detecting an operation on the second touch operating surface, and a processing device realizing a first function when the operation on the first touch operating surface is detected and realizing a second function different from the first function when the operation on the second touch operating surface is detected.

### BACKGROUND OF THE INVENTION

1. Field of the Invention

This disclosure relates to an operating device.

2. Description of Related Art

A technique is known in which an indicator portion providing a different contact-based sensation is disposed on an operating surface of a touch panel member (for example, refer to Japanese Patent Application Publication No. 2012-208762 (JP 2012-208762 A)).

In the configuration according to what is described in JP 2012-208762 A above, an operator can grasp the operating surface by touching the operating surface and relying on the indicator portion. However, no function is realized as a result of an operation on the indicator portion.

### SUMMARY OF THE INVENTION

The invention provides an operating device that is capable of realizing multiple functions in a smaller space.

An aspect of the invention relates to an operating device including a main body portion that has a first touch operating surface and a second touch operating surface which is provided at an angle with respect to the first touch operating surface, a first sensor that detects an operation on the first touch operating surface, a second sensor that detects an operation on the second touch operating surface, and a processing device that realizes a first function when the operation on the first touch operating surface is detected and realizes a second function different from the first function when the operation on the second touch operating surface is detected.

According to the invention, an operating device that is capable of realizing multiple functions in a smaller space can be provided.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 schematically illustrates the configuration of an operating device 1 for a vehicle according to an embodiment;

FIG. 2 is a perspective view schematically illustrating a main body portion 120 of a touch pad 10;

FIG. 3 is a perspective view schematically illustrating an arrangement example for an electrostatic sensor;

FIG. 4 is a cross-sectional view schematically illustrating an arrangement example for a load detecting unit;

FIG. 5 schematically illustrates an example of a direction of a load that can be provided for the main body portion 120;

FIG. 6 is a cross-sectional view schematically illustrating an arrangement example for a vibration generating unit 15;

FIG. 7 is an explanatory diagram showing examples of respective functions realized as a result of operations on a first touch operating surface 121 and a second touch operating surface 122;

FIG. 8 illustrates an example of the arrangement relationship between a display 20 and the main body portion 120; and

FIG. 9 is a top view schematically illustrating a display example of the display 20 according to the example illustrated in FIG. 8.

### DETAILED DESCRIPTION OF EMBODIMENTS

Hereinafter, embodiments will be described in detail with reference to accompanying drawings.

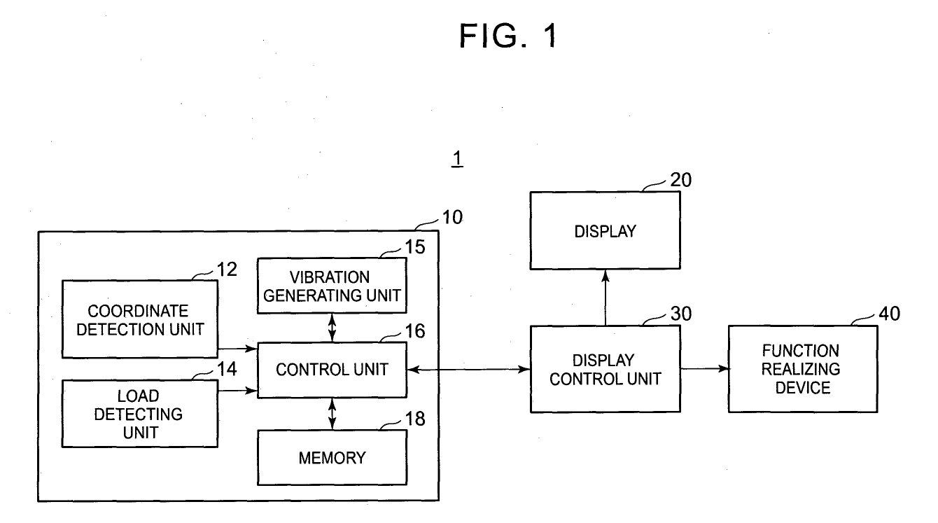

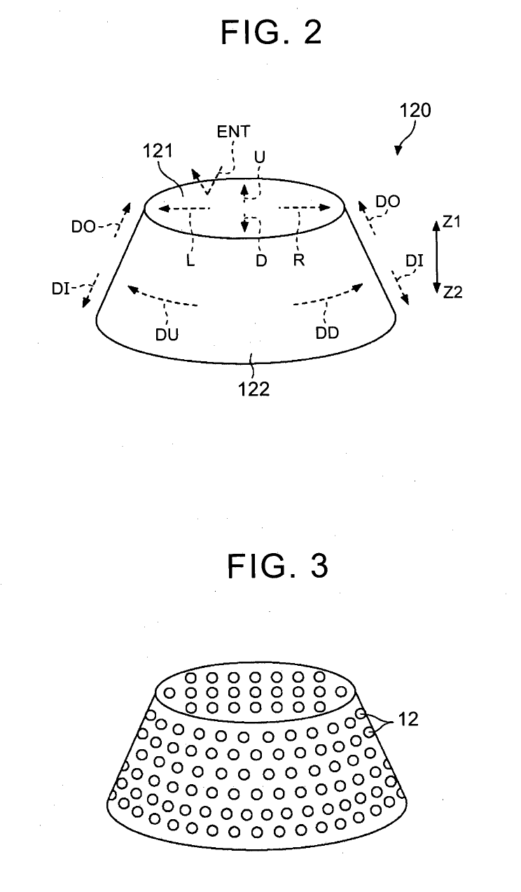

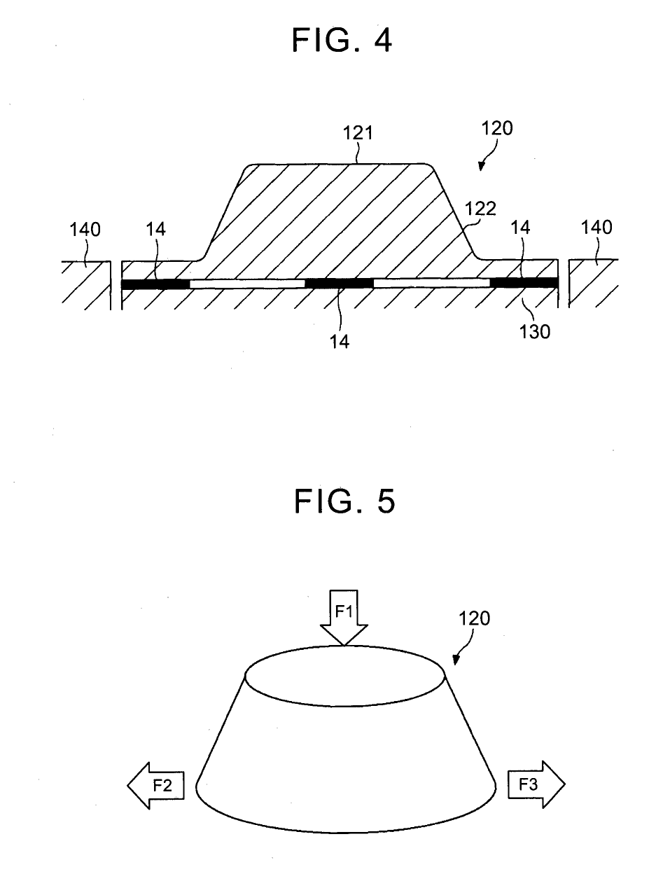

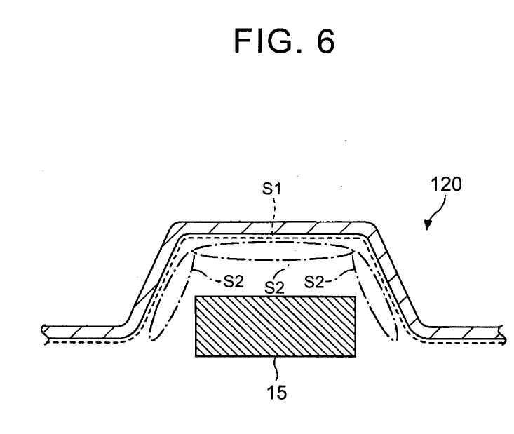

FIG. 1 schematically illustrates the configuration of an operating device 1 for a vehicle according to an embodiment. FIG. 2 is a perspective view schematically illustrating a main body portion 120 of a touch pad 10. In FIG. 2, various examples of an operation method are schematically illustrated by dotted arrows. FIG. 3 is a perspective view schematically illustrating an arrangement example for an electrostatic sensor. FIG. 4 is a cross-sectional view schematically illustrating an arrangement example for a load detecting unit. In FIG. 4, the main body portion 120 is illustrated as having a solid cross section for simplification. In actuality, however, the main body portion 120 has a space or the like therein (refer to FIG. 6). FIG. 5 schematically illustrates an example of a direction of a load that can be provided for the main body portion 120. FIG. 6 is a cross-sectional view schematically illustrating an arrangement example for a vibration generating unit 15.

The operating device 1 for a vehicle includes the touch pad 10, a display 20, and a display control unit 30. A function realizing device 40 is connected to the display control unit 30.

The touch pad 10 is disposed at an appropriate place in a passenger compartment. Preferably, the touch pad 10 is arranged at a position allowing an easy operation for a driver (position that can be reached by stretching a hand while maintaining a driving posture). For example, the touch pad 10 may be arranged on a console box or in the vicinity of the console box.

As illustrated in FIG. 2, the touch pad 10 has the main body portion 120 that has the shape of a truncated cone. The upper side in the following description is defined as one side in the direction in which the central axis of the truncated cone extends, and the lower side in the following description is defined as the other side in the direction in which the central axis of the truncated cone extends. Specifically, the Z1 side in FIG. 2 is the “upper side” and the Z2 side in FIG. 2 is the “lower side”.

As illustrated in FIG. 2, the upper surface of the main body portion 120 forms a first touch operating surface 121 and the side surface of the main body portion 120 forms a second touch operating surface 122. The first touch operating surface 121 may be formed substantially all over the upper surface of the main body portion 120 and the second touch operating surface 122 may be formed substantially all over the side surface of the main body portion 120. The side surface of the main body portion 120 does not have to be a curved surface as illustrated in FIG. 2. The side surface of the main body portion 120 may be formed by combining a plurality of flat surfaces with each other. In other words, when viewed from above, the main body portion 120 may have a polygonal external form instead of the circular external form that is illustrated in FIG. 2.

As illustrated in FIG. 1, the touch pad 10 includes a coordinate detection unit 12, a load detecting unit 14, the vibration generating unit 15, a control unit 16, and a memory 18.

The coordinate detection unit 12 is, for example, an electrostatic sensor. As schematically illustrated in FIG. 3, a plurality of the coordinate detection units 12 may be disposed on respective inner layers (refer to S1 in FIG. 6) of the upper surface and the side surface of the main body portion 120. The first touch operating surface 121 and the second touch operating surface 122 are formed in this manner. Electrodes corresponding to the respective coordinate detection units 12 may be arranged in a linear shape or in a zigzag shape across an insulator. When a human finger approaches the electrodes across a panel of the insulator, a capacitor using the electrode and the finger as polar plates is formed and the charge amount (and the capacitance resulting therefrom) of the electrode changes. In this case, a detection signal from the electrode (signal that shows the amount of change in the charge accumulated in the electrode) is transmitted to the control unit 16.

The load detecting unit 14 detects the pressure or load that is provided for the main body portion 120 of the touch pad 10. The load detecting unit 14 may be a pressure-sensitive sensor (for example, a piezoelectric element), a tact switch, or the like. As illustrated in FIG. 4, the load detecting unit 14 may be disposed between the lower surface of the main body portion 120 and a supporting portion 130. In the example that is illustrated in FIG. 4, the load detecting unit 14 detects a downward pressure or load F1 (refer to FIG. 5). A load detecting unit that detects a pressure or loads F2, F3 (refer to FIG. 5) in a transverse direction may be disposed in addition to or instead of the load detecting unit 14. In this case, the load detecting unit may be a strain sensor or the like that detects a shear force or may be a pressure-sensitive sensor, a tact switch, or the like that is disposed between the main body portion 120 and an outer peripheral frame 140. The pressure or loads F2, F3 in the transverse direction are illustrated in the example that is illustrated in FIG. 5, and a pressure or load in a front-back direction (direction perpendicular to both an up-down direction and the transverse direction) may be detected in addition thereto or instead thereof. In a case where the pressure or load in the front-back direction is detected along with the pressure or loads F2, F3 in the transverse direction, the main body portion 120 also forms an operation member such as a joystick that allows a front-back operation, a right-left operation, and an operation based on a combination between the front-back operation and the right-left operation as well as an operation member such as the touch pad. In a case where the downward pressure or load F1 is detected, the main body portion 120 also forms an operation member such as a joystick that allows a push-down operation as well as the operation member such as the touch pad.

The vibration generating unit 15 may be an actuator, a weight, or the like that generates vibration. The vibration generating unit 15 may be arranged at any place in the main body portion 120 insofar as the generated vibration is transmitted to the place. For example, the vibration generating unit 15 is disposed below a central portion in the main body portion 120 in the example that is illustrated in FIG. 6. The vibration generating unit 15, however, may be arranged below a peripheral portion in the main body portion 120. Also, the vibration generating unit 15 may be disposed at multiple dispersed positions in the main body portion 120.

The control unit 16 and the memory 18 are configured to have, for example, a microcomputer. The control unit 16 and the memory 18 may be arranged in the main body portion 120 of the touch pad 10 or may be arranged outside the main body portion 120.

The control unit 16 generates, based on an output (detection signal) from the coordinate detection unit 12, a coordinate signal that shows a coordinate position in the operating surface, that is, a coordinate signal that shows a coordinate position touch-operated by an operator (position of an operating finger). In a case where the coordinate detection unit 12 is an electrostatic sensor, charges are accumulated in the capacitor that has the electrodes and the operating finger as described above. The amount of change in the charges in the respective electrodes depends on the position of the operating finger, and thus the position of the operating finger can be specified based on the detection signals from the respective electrodes. Specifically, in a case where the output from the coordinate detection unit 12 exceeds a predetermined reference value, the control unit 16 generates the coordinate signal based on the maximum position of the output from the coordinate detection unit 12. The predetermined reference value is, for example, a value associated with the amount of change in the charge accumulated in the electrode. In a case where the amount of change in the charge accumulated in the electrode (maximum amount of change in the charge) exceeds the reference value, for example, the control unit 16 determines that the operation by the operator is underway and generates the coordinate signal (for example, coordinate signal that shows the electrode position at which the amount of change in the charge is the maximum). In a case where the amount of change in the charge accumulated in the electrode does not exceed the reference value, the control unit 16 determines that the operation by the operator is not underway and does not generate the coordinate signal. The reference value may be stored in the memory 18. The control unit 16 transmits the generated coordinate signal to the display control unit 30.

The control unit 16 generates a determination signal based on an output from the load detecting unit 14 (detection signal that shows the pressure or load). In a case where the output (pressure) from the load detecting unit 14 exceeds a predetermined threshold Pn, for example, the control unit 16 detects a determination operation by the operator and generates the determination signal. The generated determination signal is transmitted to the display control unit 30. In a case where a plurality of pressure-sensitive sensors are disposed as the load detecting unit 14 as illustrated in FIG. 4, the control unit 16 may generate the determination signal in a case where the output from any one of the pressure-sensitive sensors exceeds the predetermined threshold Pn. In this case, the pressure-sensitive sensor may be disposed so as to detect only the presence or absence of a pressing operation on the main body portion 120, without a plurality of the pressure-sensitive sensors having to be disposed so as to detect a pressing position on the main body portion 120. Accordingly, the determination signal is a signal that shows only the detection of the determination operation, and may be a signal not containing any other information such as the position of the pressing operation. The control unit 16 transmits the generated determination signal to the display control unit 30.

When the determination operation is detected, the control unit 16 generates vibration on the operating surface of the coordinate detection unit 12 by using the vibration generating unit 15. Then, the operator can perceive the realization of the determination operation from his or her fingertip. When a selection item is changed through a selection operation, the control unit 16 generates vibration on the operated operating surface (first touch operating surface 121 or second touch operating surface 122) by using the vibration generating unit 15. Then, the operator can perceive the selection item change through the selection operation from his or her fingertip. These vibrations are solely for the above-described feedback function for the operator (function for giving a pseudo click feeling), and thus may be generated for an extremely short period of time (instantaneously as is the click). In the case of an operation for adjusting settings such as sound volume, air volume, and temperature, the control unit 16 may generate the click feeling by the number of times corresponding to the amount of change in the settings. In the case of an operation for changing the set temperature from 22 degrees to 25 degrees, for example, the control unit 16 may generate the click feeling three times (=25−22).

The control unit 16 communicates with the display control unit 30 and transmits various types of information (coordinate signal, determination signal, message output request, and the like) to the display control unit 30.

The display 20 may be any display device such as liquid crystal display and head-up display (HUD). The display 20 is arranged at an appropriate position (for example, instrument panel) in the passenger compartment. The display 20 may be a touch panel display or may be a display that cannot be touch-operated.

The display control unit 30 is configured to have, for example, a microcomputer and may have the form of an ECU. Any type of connection is possible between the display control unit 30 and the touch pad 10. The connection may be wired connection, wireless connection, or a combination thereof and may be direct connection or indirect connection. Some or all of the functions of the display control unit 30 may be realized by the control unit 16 for the touch pad 10 and a control unit (not illustrated) in the display 20 and some or all of the functions of the control unit 16 for the touch pad 10 may be realized by the display control unit 30.

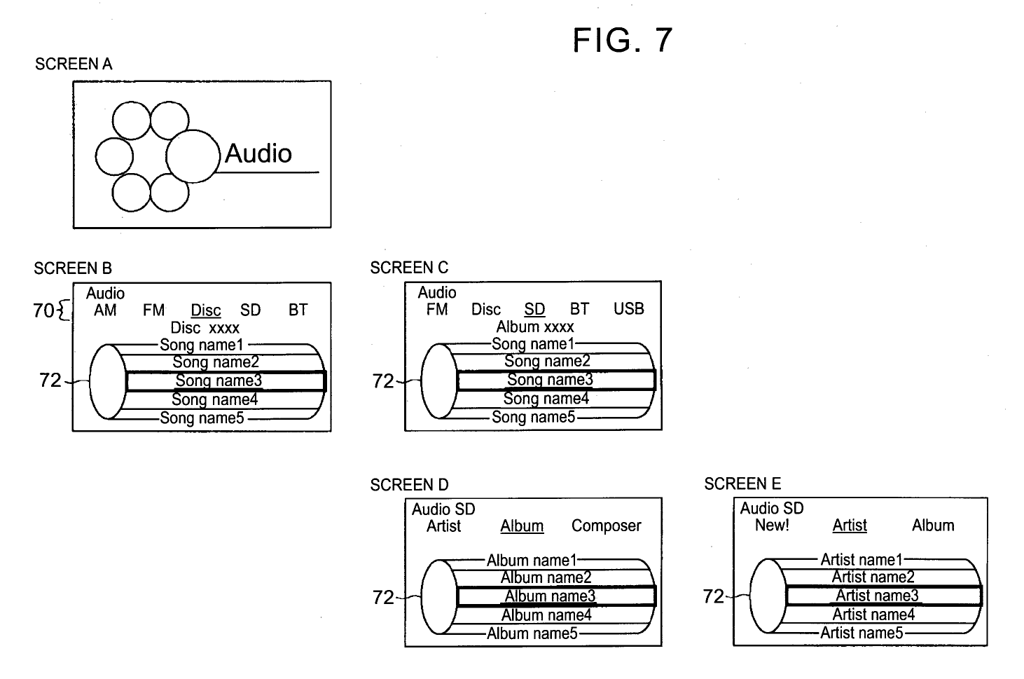

The display control unit 30 assists in the operation on the touch pad 10 by synchronizing the display 20 and the touch pad 10 with each other. Specifically, the display control unit 30 displays an operation screen (refer to FIG. 7) on the display 20 and performs selection and determination processing or the like for various selection items (refer to FIG. 7) based on the signals (coordinate signal and determination signal) from the touch pad 10. The selection and determination processing or the like for the various selection items (refer to FIG. 7) include screen transition processing and processing for outputting a command to the function realizing device 40. The function realizing device 40 may include, for example, an audio device, a TV, a navigation device, and an air-conditioning device. The display control unit 30 may give priority to the determination signal in a case where the determination signal and the coordinate signal are received at the same time.

The selection items constitute virtual operation buttons (meaning buttons other than a mechanical button directly operated by hand). The selection items (operation buttons) may relate to any type (function). In other words, the content that can be operated on the touch pad 10 may not be limited. For example, the selection items may include a selection item for displaying (calling), on the display 20, a screen (operation screen) for performing various types of setting for the navigation device and a map screen (for example, current location display screen). In addition, the selection items may include a selection item for performing various types of setting for the air-conditioning device and a selection item for displaying the screen on the display 20. In addition, the selection items may include a selection item for performing various types of setting for audio and TV (sound volume adjustment and the like) and a selection item for displaying the screen on the display 20. In addition, the selection items may include a selection item for starting any application (icon, launcher, or widget). In addition, the selection items may include a character input button on an operation screen such as a 50 sound input screen.

The display control unit 30 detects respective operations on the first touch operating surface 121 and the second touch operating surface 122 based on the coordinate signal from the touch pad 10. Preferably, the operation on the first touch operating surface 121 includes a plurality of types of operations. Preferably, the operation on the second touch operating surface 122 includes a plurality of types of operations.

Herein, examples of the operations on the first touch operating surface 121 include an operation U following the front side (the other side when viewed from the operator) of the first touch operating surface 121, an operation D following the rear side (the side close to the operator) of the first touch operating surface 121, an operation L following the left side of the first touch operating surface 121, and an operation R following the right side of the first touch operating surface 121 as illustrated in FIG. 2. In addition, the operations on the first touch operating surface 121 include a tap operation ENT for tapping the first touch operating surface 121. Examples of the operations on the second touch operating surface 122 include, as illustrated in FIG. 2, an operation DU following the clockwise direction on the second touch operating surface 122, an operation DD following the counterclockwise direction on the second touch operating surface 122, an operation DO following the upper side of the second touch operating surface 122, and an operation DI following the lower side of the second touch operating surface 122. In addition, the operations on the first touch operating surface 121 and/or the operations on the second touch operating surface 122 may include a double tap operation, a flick operation in each direction, a pinch operation, and the like.

When the respective operations on the first touch operating surface 121 and the second touch operating surface 122 are detected, the display control unit 30 realizes different functions in accordance with the types of the operations. For example, the function that is realized by the display control unit 30 when the operation L following the left side of the first touch operating surface 121 is detected is different from the function that is realized by the display control unit 30 when the operation R following the right side of the first touch operating surface 121 is detected. Any function can be assigned to each operation type, and the function depends on the state of the operation screen during the assignment.

FIG. 7 is an explanatory diagram showing examples of the respective functions realized as a result of the operations on the first touch operating surface 121 and the second touch operating surface 122, and the screens A to E in FIG. 7 illustrate an example of the transition of the operation screen on the display 20. Regarding the positional relationship between the screens A to E in FIG. 7, the up-down direction represents the screen transition for higher or lower hierarchy and the transverse direction represents the screen transition in the same hierarchy.

The screen A shows an example of a function selection screen. The six circles in the screen A represent selection items. Herein, the selection items are, for example, selection items for calling a screen for performing various types of setting and are prepared for respective devices such as audio, TV, and air-conditioning device. Displays such as characters representing the selection items may be provided in the six circles. In the example that is illustrated as the screen A, the selection item that is positioned at the center of the screen and is associated with the audio is in a “selected state”. The selection item that is in a selected state can be changed by the operation DU and the operation DD (refer to FIG. 2). For example, if the operation DU (refer to FIG. 2) following the clockwise direction on the second touch operating surface 122 is detected, the display control unit 30 rotates the six-circle ring shown in the screen A in the clockwise direction so that the selection item reaching the center of the screen (enlarged circle) is in the “selected state”.

In the event of the detection of the tap operation ENT or the operation DI or the reception of the determination signal during the display of the function selection screen A, the display control unit 30 realizes screen transition (example of the functions) from the function selection screen A to the operation screen B that is one hierarchy below. The operation screen B is an example of the operation screen for a case where the tap operation ENT or the operation DI (refer to FIG. 2) is detected while the selection item associated with the audio is in the “selected state”. The operation screen B includes a selection item group display 70 for source switching for switching the source that is the origin of the music or the like which is output and a selection item group display 72 for song selection. The source may include, for example, FM broadcasting, AM broadcasting, disk (CD, MD, or the like), SD card, Bluetooth (registered trademark), and USB. In the example that is shown as the screen B, the selection item associated with the disk is in the “selected state” in the selection item group display 70 for source switching and the selection item for the song name in the disk having the “Song name 3” is in the “selected state” in the selection item group display 72 for song selection. Herein, as an example, each of the selection items in the selection item group display 70 for source switching can be scrolled in the right-left direction and each of the selection items in the selection item group display 72 for song selection can be scrolled in the direction of rotation. In this case, if the display control unit 30 detects the operation L (refer to FIG. 2), for example, each of the selection items in the selection item group display 70 for source switching is scrolled to the left direction and the selection item in the “selected state” is changed (refer to the screen C in FIG. 7). If the operation R (refer to FIG. 2) is detected, the display control unit 30 scrolls each of the selection items in the selection item group display 70 for source switching to the right direction so that the selection item in the “selected state” is changed. If the operation DU (refer to FIG. 2) is detected, the display control unit 30 scrolls each of the selection items in the selection item group display 72 for song selection in the clockwise direction so that the selection item in the “selected state” is changed. If the operation DD (refer to FIG. 2) is detected, the display control unit 30 scrolls each of the selection items in the selection item group display 72 for song selection in the counterclockwise direction so that the selection item in the “selected state” is changed.

If the operation DO (refer to FIG. 2) is detected during the display of the screen B or the screen C, the display control unit 30 realizes screen transition (example of the functions) to the function selection screen A. If the operation L or the operation R (refer to FIG. 2) is detected as described above during the display of the screen B, the display control unit 30 realizes screen transition to the selection screen C following source switching. In this manner, a user can switch the source as necessary by the operation L or the operation R and can search for a desired selection item as necessary, by the operation DD or the operation DU, after the switching. In the event of the detection of the tap operation ENT (refer to FIG. 2) or the reception of the determination signal during the display of the screen B or the screen C, the display control unit 30 realizes the function associated with the selection item that is in the selected state at that point in time. In a case where the screen B is displayed, for example, the display control unit 30 outputs a command for initiating the playback of the song having the “Song name 3” to the audio device (example of the function realizing device 40).

In the event of the detection of the operation DI (refer to FIG. 2) during the display of the screen C, the display control unit 30 realizes screen transition (example of the functions) to the operation screen D that is one hierarchy below. The operation screen D is a screen that allows song selection in a hierarchy below the operation screen C. Specifically, the respective songs are sorted by attribute such as artist, album, and composer in the source in the selected state (SD card in this example), and a desired song can be selected from the attributes. In the event of the detection of the operation L or the operation R (refer to FIG. 2) during the display of the screen D, the display control unit 30 realizes screen transition to the selection screen E following the attribute switching. In the event of the detection of the operation DU (refer to FIG. 2) during the display of the screen D or the screen E, the display control unit 30 scrolls each of the selection items in the selection item group display 72 for song selection in the clockwise direction so that the selection item in the “selected state” is changed. In the event of the detection of the operation DD (refer to FIG. 2), the display control unit 30 scrolls each of the selection items in the selection item group display 72 for song selection in the counterclockwise direction so that the selection item in the “selected state” is changed. Likewise, in the event of the detection of the tap operation ENT (refer to FIG. 2) or the reception of the determination signal during the display of the screen D or the screen E, the display control unit 30 realizes the function associated with the selection item that is in the selected state at that point in time. In the case of the screen D, for example, the display control unit 30 outputs a command for initiating the playback of the song in the album having the “Album name 3” to the audio device (example of the function realizing device 40). In this case, the audio device may initiate the playback of the first song in the album having the “Album name 3”. In the case of the screen E, the display control unit 30 outputs a command for initiating the playback of the song of the artist having the “Artist name 3” to the audio device (example of the function realizing device 40). In this case, the audio device may initiate the playback of the first song in the sorting order for the songs of the artist having the “Artist name 3”. In the event of the detection of the operation DI (refer to FIG. 2) during the display of the screen D or the screen E, the display control unit 30 realizes screen transition to a selection screen further low hierarchy (not illustrated). In the event of the detection of the operation DI (refer to FIG. 2) during the display of the screen D, for example, the display control unit 30 may output a song selection screen in the album having the “Album name 3”. In the event of the detection of the operation DO (refer to FIG. 2) during the display of the screen D or the screen E, the display control unit 30 realizes screen transition (example of the functions) to the operation screen C that is one hierarchy above.

In this manner, the user can realize various functions by performing various operations on the first touch operating surface 121 and the second touch operating surface 122 of the main body portion 120. In other words, the main body portion 120 can realize functions similar to those of an operating device that is provided with a plurality of mechanical switches. In this manner, the multiple functions can be realized in a smaller space.

The example that is illustrated in FIG. 7 is only one example, and other assignment methods may be adopted instead thereof. The example that is illustrated in FIG. 7 relates to an audio device but can be applied to, for example, various types of setting for an air-conditioning device (temperature, air volume, and the like).

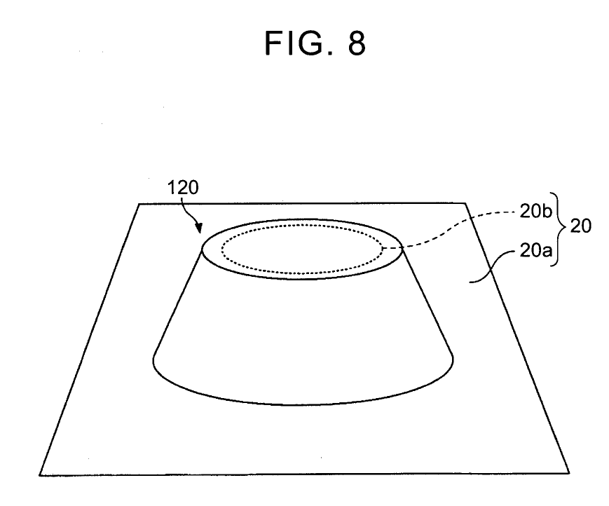

FIG. 8 illustrates an example of the arrangement relationship between the display 20 and the main body portion 120. The display 20 may be arranged apart from the main body portion 120 or the display 20 may be arranged integrally with the main body portion 120 as illustrated in FIG. 8.

In the example that is illustrated in FIG. 8, the display 20 includes a peripheral display unit 20a and an operating device inside display unit 20b. The peripheral display unit 20a is disposed around the main body portion 120. The operating device inside display unit 20b is disposed in the main body portion 120 to be seen through the upper surface of the main body portion 120. The operating device inside display unit 20b may be disposed in, for example, the space S2 that is illustrated in FIG. 6.

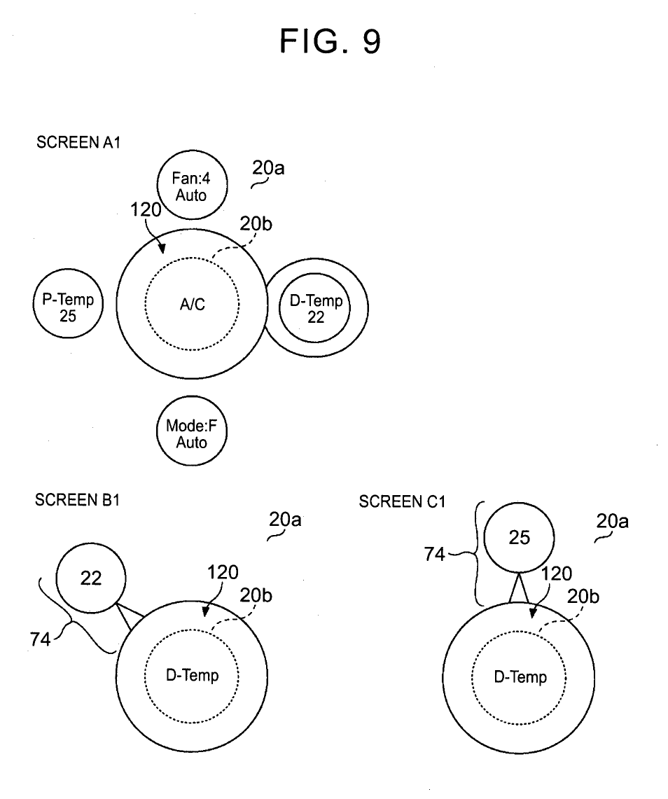

FIG. 9 is a top view schematically illustrating a display example of the display 20 according to the example illustrated in FIG. 8. The screen A1 and the screen B1 that are illustrated in FIG. 9 show operation screen transition examples on the display 20.

The screen A1 shows an example of a setting screen for an air-conditioning device. In the example that is illustrated as the screen A1, display “A/C” that represents the setting screen for the air-conditioning device is output to the operating device inside display unit 20b. Selection items for calling air volume, temperature, and mode setting change screens are displayed with four circles in the peripheral display unit 20a. Characters showing the setting change items (for example, D-Temp) and the current setting state (for example, 22) are displayed in the circles. In the example that is illustrated as the screen A1, the selection item that is associated with driver's seat-side temperature setting, which is positioned on the right side of the main body portion 120, is in the “selected state”. The selection item that is in a selected state can be changed by the operation DU and the operation DD (refer to FIG. 2). In the event of the detection of the operation DU (refer to FIG. 2) following the clockwise direction on the second touch operating surface 122, for example, the display control unit 30 rotates the four-circle ring shown in the screen A1 in the clockwise direction so that the selection item reaching the right side of the main body portion 120 (enlarged circle) is in the “selected state”. In this case, the control unit 16 may generate the click feeling by the number of times corresponding to the amount of rotation by using the vibration generating unit 15. For example, the control unit 16 may generate, by using the vibration generating unit 15, the click feeling once each time the four-circle ring rotates circle by circle in the clockwise direction. In this case, the display control unit 30 may transmit information showing the amount of rotation of the ring to the control unit 16.

In the event of the detection of the operation DI (refer to FIG. 2) during the display of the setting screen A1 for the air-conditioning device, the display control unit 30 realizes screen transition to the driver's seat-side temperature setting screen B1 that is one hierarchy below. In the example that is illustrated as the screen B1, the display “D-Temp” that represents the driver's seat-side temperature setting screen is output to the operating device inside display unit 20b. A display 74 that represents the current set temperature is output to the peripheral display unit 20a. The display 74 includes the display of the number “22” showing that the current set temperature is 22 degrees. In the event of the detection of the operation DU (refer to FIG. 2) during the display of the screen B1, the display control unit 30 increases the number in the display 74 while moving the display 74 in the clockwise direction about the center of the main body portion 120. In this case, the display control unit 30 transmits the increased set temperature to the air-conditioning device (example of the function realizing device 40). In this case, the control unit 16 may generate, by using the vibration generating unit 15, the click feeling by the number of times corresponding to the amount of change in the temperature. The screen C1 represents the driver's seat-side temperature setting screen that is obtained after the movement of the display 74 in the clockwise direction about the center of the main body portion 120 and the increase in the number in the display 74 by three. In this case, the control unit 16 may generate the click feeling six times (corresponding to three degrees by 0.5-degree increment) by using the vibration generating unit 15. In the event of the detection of the operation DD (refer to FIG. 2), the display control unit 30 decreases the number in the display 74 while moving the display 74 in the counterclockwise direction about the center of the main body portion 120. In this case, the display control unit 30 transmits the decreased set temperature to the air-conditioning device (example of the function realizing device 40). Likewise, in this case, the control unit 16 may generate, by using the vibration generating unit 15, the click feeling by the number of times corresponding to the amount of change in the temperature. In the event of the detection of the operation DO (refer to FIG. 2) during the display of the driver's seat-side temperature setting screen B1, the display control unit 30 realizes screen transition to the setting screen A1 for the air-conditioning device.

Each embodiment has been described in detail above, but the invention is not limited to the specific embodiment. The invention can be modified or changed in various manners without departing from the scope of the claims. Also, some or all of the elements constituting the embodiment described above can be combined with each other.

For example, although the main body portion 120 according to the embodiment described above has the shape of a truncated cone, the shape may be any other three-dimensional shape having two or more operating surfaces forming an angle. In this case, the angle that is formed by the two operating surfaces may exceed 90 degrees as with the angle that is formed by the first touch operating surface 121 and the second touch operating surface 122 or may be 90 degrees. In a case where the angle is 90 degrees, the shape is a cylindrical shape. The operability is higher when the angle exceeds 90 degrees with the lower side of the second touch operating surface 122 spreading out. In addition, the two operating surfaces may be connected to each other via a curved surface. In addition, the main body portion 120 may be partially cut out to have a concave portion and a convex portion.

The load detecting unit 14 and the vibration generating unit 15 are disposed in the preferred embodiment described above. However, one or both of the load detecting unit 14 and the vibration generating unit 15 may be omitted. For example, the load detecting unit 14 may be omitted in a case where the display control unit 30 can detect the tap operation ENT on the first touch operating surface 121 as described above.

In the embodiment described above, the feedback for the user is provided by the vibration generated by the vibration generating unit 15. However, the feedback for the user may be provided by using, for example, sound, light, or static electricity (sensation) instead of the vibration.

1. An operating device comprising:
a main body portion that has a first touch operating surface and a second touch operating surface which is provided at an angle with respect to the first touch operating surface;
a first sensor that detects an operation on the first touch operating surface;
a second sensor that detects an operation on the second touch operating surface; and
a processing device that realizes a first function when the operation on the first touch operating surface is detected and realizes a second function different from the first function when the operation on the second touch operating surface is detected.

2. The operating device according to claim 1,
wherein at least one of the first function and the second function includes a function for setting adjustment.

3. The operating device according to claim 1,
wherein the main body portion has a shape of a truncated cone or a cylinder, and
wherein the first touch operating surface is formed on an upper surface of the main body portion and the second touch operating surface is formed on a side surface of the main body portion when one side in a direction in which a central axis of the truncated cone or the cylinder extends is defined as the upper surface and the other side in the direction in which the central axis of the truncated cone or the cylinder extends is defined as a lower side.

4. The operating device according to claim 3,
wherein the operation on the second touch operating surface includes an operation in a direction of rotation about the central axis of the truncated cone or the cylinder and an operation in an up-down direction, and
wherein the function realized by the processing device when the operation in the direction of rotation is detected is different from the function realized by the processing device when the operation in the up-down direction is detected.

5. The operating device according to claim 1,
wherein the operation on the first touch operating surface includes at least two types of operations, and
wherein the processing device realizes different functions in accordance with the types of the operations.

6. The operating device according to claim 1,
wherein the first sensor includes an electrostatic sensor, and one of a pressure-sensitive sensor, a tact switch, and a strain sensor,
wherein the operation on the first touch operating surface includes a first operation detected by the electrostatic sensor and a second operation detected by the one of the pressure-sensitive sensor, the tact switch, and the strain sensor, and
wherein the function realized by the processing device when the first operation is detected is different from the function realized by the processing device when the second operation is detected.
